(19) United States
(12) Patent Application Publication
(10) Pub. No.: US 2006/0108881 A1
(43) Pub. Date: May 25, 2006

(54) Electric machine, particularly a brushless direct current motor

(76) Inventors: Willi Hauger, Villingen-Schwenningen (DE); Helmut Ganter, Bad Durrheim (DE); Helmut Hans, Sankt Georgen (DE)

Correspondence Address: Mark C. Comtois;DUANE MORRIS LLP, Suite 700, 1667 K Street, N.W., Washington, DC, 20006, US

(21) Appl. No.: 11/282,051

(22) Filed: Nov. 18, 2005

(30) Foreign Application Priority Data
Aug. 3, 2005 (DE) 10 2005 036 558.2
Nov. 22, 2004 (DE) 10 2004 056 303.9

(51) Int. Cl. H02K 11/00; H02K 23/66

(52) U.S. Cl. 310/68 B

(57) ABSTRACT

An electric machine, in particular a brushless DC motor, having a stator arrangement and a rotor arrangement that are arranged coaxially with respect to one another, the rotor arrangement having a rotor body and permanent magnets embedded in the rotor body, at least one magnetic sensor for the purpose of measuring the rotational position of the rotor body being disposed at an end face of the rotor body and being located directly opposite this end face

### FIELD OF THE INVENTION

The invention relates to an electric machine, and in particular a brushless direct current motor comprising a stator arrangement and a rotor arrangement that are aligned coaxially with respect to one another, the rotor arrangement having a rotor body and permanent magnets embedded in the rotor body.

### BACKGROUND OF THE INVENTION

A preferred field of application for the invention is in brushless DC motors and other permanent magnet motors that can be configured as inner rotor motors or as outer rotor motors. Electric motors in which the invention finds application have a rotor body that is mounted onto a shaft, permanent magnets being embedded in the rotor body, preferably in a spoke-like arrangement. The motors further comprise a stator arrangement that generally consists of a number of stacked metal laminations which form an annular stator back yoke from which stator teeth extend either radially inwards or radially outwards. The stator teeth form the stator poles between which stator slots to receive stator windings are formed. The rotor arrangement is inserted either coaxially into the stator arrangement (for an inner rotor configuration), or it encloses the stator coaxially (for an outer rotor configuration).

In order to generate commutation signals when brushless DC motors are in operation, it is necessary to measure the rotational position of the rotor. Moreover, in various applications it is advantageous to also measure the rotational speed as well as the rotational direction. Rotational position sensors are normally used in the prior art for this purpose. In practice, these kinds of rotational position sensors mainly take the form of Hall elements, although other magnetic sensors, such as MR (magneto resistive) or GMR (giant magneto resistive) sensor elements are also known.

In motors in which the magnets are disposed on the circumference of an annular rotor back yoke, it is known to employ vertical, leaded Hall elements that can measure the polarity of the magnetic field emitted radially from the rotor. An arrangement of this kind is illustrated in FIGS. 1a and 1b. FIG. 1a shows a longitudinal section through a brushless DC motor according to the prior art; FIG. 1b shows a section through the plane A-A of FIG. 1a.

The motor comprises a shaft 10 that carries a rotor arrangement. The rotor arrangement comprises a rotor back yoke 12 and one or more permanent magnets 14 mounted on the outer circumference of the rotor back yoke 12. The rotor arrangement is coaxially inserted into a stator arrangement that comprises a stator body 16 and windings 18. The stator body 16 is built up, for example, from a stack of stamped laminations. The winding 18 is schematically illustrated in FIG. 1a by its winding heads 18′, 18″.

As can be seen from FIG. 1a, the rotor arrangement 12, 14 is lengthened in an axial direction and extends at one end face to the approximate height of the corresponding winding head 18′. A circuit board 20 that carries Hall elements is disposed at this end face. The axial extension of the rotor arrangement 12, 14 has the purpose of allowing the Hall elements to detect the radial field components of the rotor magnets 14d.

The extension of the rotor arrangement 12, 14 in an axial direction gives rise to non-negligible extra costs for ferromagnetic and magnetic material as well as certain additional manufacturing work and expense. What is more, the Hall elements 22 are subject to disturbance from the magnetic fields of the adjoining stator coils.

In the arrangement according to the prior art as shown in FIGS. 1a and 1b, leaded components are preferably used for the Hall elements 22, it being necessary to solder these leaded components onto the circuit board 20 thus creating additional costs. In this embodiment, the radial stray field of the permanent magnets 22 is measured.

In the prior art, it is also known to measure the axial stray field of the permanent magnets of a rotor arrangement. An example of this is shown in FIGS. 2a and 2b. In FIGS. 2a and 2b, parts that are similar to those in the previous figures are indicated by the same reference numbers. Again in FIG. 2a, the permanent magnets 14 are disposed on the outer circumference of the rotor body 12. In this case, however, the rotor body is not lengthened in an axial direction, but rather a circuit board 20 is disposed at its end face, the circuit board 20 carrying Hall elements 22 and being located opposite the end face of the rotor arrangement 12, 14. The circuit board 20 is seated within the winding heads 18′. This embodiment has the advantage that the rotor arrangement need not be extended in an axial direction, which means that, compared to the first embodiment, material can be saved and the overall height of the motor need not be increased. The disadvantage of this version is that the axial stray field of the permanent magnets 14 is significantly weaker than the radial stray field, which means that the Hall elements 22 have only a correspondingly weak signal to receive and evaluate.

Another means of measuring the rotational position according to the prior art is illustrated in FIGS. 3a and 3b.

The rotor arrangement and stator arrangement of FIGS. 3a and 3b correspond in full to those of FIGS. 2a and 2b. Unlike the embodiments described above, however, neither the axial nor the radial stray field of the permanent magnets 14 of the rotor are used to measure the rotational position of the rotor arrangement 12, 14. Instead, separate sensor magnets, independent of the permanent magnets 14, are disposed on a separate carrier 26 that is located at an end face of the rotor arrangement 12, 14 and fixedly attached to the shaft 10. The Hall elements 22 are disposed on a circuit board 20 that aligns the Hall elements 22 to the sensor magnets 24 as shown in FIG. 3a. In this embodiment, the sensor magnets 24 are magnetized, for example, in an axial direction and can be disposed at such a spacing to the stator windings 18 that the windings cannot cause any significant disturbance. The diameter of the sensor magnets 24 is independent of the diameter of the permanent magnets 14, which means that the arrangement of the Hall elements 22 on the circuit board 20 and their relative position to the sensor magnets 24 can be optimized independently of where the permanent magnets 14 are disposed.

Although the arrangement shown in FIGS. 3a, 3b makes it possible to achieve good measurement results with respect to the rotor position of the rotor arrangement 12, 14, the arrangement creates additional work and expense in the assembly of the motor and increases the overall length of the motor as a whole. In addition, the rotor magnets and the sensor magnet ring have to be aligned with respect to each other.

It is an object of the invention to provide an electric machine, particularly a brushless DC motor, that allows the rotational position of the motor to be reliably measured using a simple design and construction.

### SUMMARY OF THE INVENTION

According to one aspect, the invention provides an electric machine, and in particular a brushless DC motor, having a stator arrangement and a rotor arrangement. The stator and rotor are arranged coaxially with respect to each other in a manner that is well-known, with it being possible to apply the invention to both an inner rotor as well as an outer rotor configuration. The rotor arrangement comprises a rotor body and permanent magnets embedded in the rotor body. For the purpose of measuring the rotational position of the rotor body, at least one magnetic sensor is disposed at an end face of the rotor body, the magnetic sensor being located directly opposite this end face.

To date, it has not been usual in the prior art to use magnetic sensors in conjunction with embedded permanent magnets of a rotor to measure the rotational position of the rotor. This technique has considerable advantages that are not found in rotor arrangements having permanent magnets mounted on their outer circumference, which means that the above-described prior art cannot be simply transferred to the invention without further effort.

Although a person skilled in the art may be initially reticent to apply the technique described in reference to FIGS. 1 and 2 to rotors having embedded permanent magnets, the inventor has found that rotors having embedded permanent magnets have the great advantage for the purposes of the invention that they generate a high axial stray field in the region of the end face of the rotor. The permanent magnets are preferably arranged spoke-like in the rotor body and the magnetic sensor or sensors are arranged opposite the end face of the rotor in a similar way as shown in the embodiment of FIGS. 2a, 2b in order to measure the axial stray field of the permanent magnets embedded in the rotor.

Compared to the solutions of the prior art, the solution according to the invention does not require any additional work and expense for assembly nor any extra costs for additional magnetic material and suchlike. Compared to the embodiment of FIG. 3a, work and expense is greatly reduced as no separate sensor magnets are required nor does the position of such magnets have to be precisely aligned with respect to the permanent magnets of the rotor. Due to the high axial stray field of the embedded permanent magnets, it is possible to have a comparably larger spacing between the magnetic sensors and the rotor of up to a millimetre without the quality of the measured signals being significantly harmed by this. The distance tolerances for the assembly of the magnetic sensors are also greater than in the solutions provided by the prior art. Moreover, to measure the axial field components of the embedded rotor magnets, horizontal Hall sensors, particularly in an SMD construction, can be used which makes cost-effective production possible.

On the other hand, in the case of rotational position transducers having separate sensor magnets according to the prior art, after the sensor magnets have been mounted, the individual sensor magnets or the sensor magnet ring have to be coordinated with the permanent magnets of the rotor in order to prevent any misalignment between the sensor magnet ring and the permanent magnets. Any fault in the positioning of the sensor magnets would result in a faulty commutation signal. Moreover, if separate sensor magnets are provided, which are often realized in the form of a magnet-carrying ring fixedly connected to the rotor, additional tolerances arise which can falsify the positional deviation of the measured position. The solutions of the prior art that operate without having separate sensor magnets, on the other hand, have the disadvantage that the measured signals are either too weak (solutions of FIGS. 2a, 2b) or that it is necessary to extend the rotor which results in perceptibly higher costs (FIGS. 1a, 1b).

In a preferred embodiment of the invention, recesses are formed in the rotor body to receive the permanent magnets, the recesses being open on at least the end face at which the magnet sensor or sensors are disposed. This makes it possible for a particularly large axial stray field to be measured.

Another preferred embodiment of the invention provides for the rotor body to be sealed by a non-magnetic material such as plastics or aluminum. This does not go to reduce the axial stray field of the embedded magnets.

It is expedient if the magnetic sensor or sensors are arranged on an annulus whose radius lies between the inner and the outer radius of the embedded permanent magnets. In other words, the magnetic sensors thus lie on the annulus that is defined by the dimensions of the permanent magnets. Examples of magnetic sensors that can be used include Hall sensors, MR sensors and GMR sensors, two, three, or four magnetic sensors being preferably disposed at the end face of the rotor body, offset in phase at 180°, 120° or 90°.

In a particularly simple embodiment, the magnetic sensors are directly disposed on a circuit board. Depending on the distance to the end face of the rotor arrangement, the magnetic sensors can be arranged either vertically or horizontally in order to measure a tangential component or an axial component respectively of the axial magnetic stray field of the permanent magnets. Horizontal sensors are preferably used to detect the axial stray flux component.

In another embodiment of the invention, a sleeve is inserted between the rotor arrangement and the stator arrangement, as is described in German Patent Application DE 10 2004 056 303.9. This sleeve can be made of a ferromagnetic material and is connected to the free ends of the stator teeth. The sleeve has slits or de-magnetized zones between the individual poles in order to magnetically isolate the poles from one another. The sleeve preferably protrudes in an axial direction beyond the end face of the rotor arrangement at which the magnetic sensors lie. This makes it possible to shield the magnetic field of the stator towards the rotor and thus prevent the measurement of the rotational position of the rotor from being falsified. Due to the shielding effect of the axially protruding sleeve, the magnetic sensors are not influenced by the magnetic field of the stator and can thus determine the rotational position of the rotor more accurately.

### SHORT DESCRIPTION OF DRAWINGS

The invention is described in more detail below on the basis of a preferred embodiment with reference to the drawings. The figures show:

FIG. 1a a longitudinal view through a brushless DC motor according to the prior art;

FIG. 1b a cross-sectional view through the motor of FIG. 1a along the line A-A;

FIG. 2a a longitudinal view through a brushless DC motor according to the prior art;

FIG. 2b a cross-sectional view through the motor of FIG. 2a along the line A-A;

FIG. 3a a longitudinal view through a brushless DC motor according to the prior art;

FIG. 3b a cross-sectional view through the motor of FIG. 3a along the line A-A;

FIG. 4a a longitudinal view through a brushless DC motor according to the invention;

FIG. 4b a cross-sectional view through the motor of FIG. 4a along the line A-A;

FIG. 4c a cross-sectional view through the motor of FIG. 4a along the line B-B;

FIG. 5 a cross-sectional view through a part of the electric motor according to the invention, which is similar to the view in FIG. 4c, for the purpose of explaining the position of the magnetic sensors; and

FIG. 6 a perspective external view of the electric motor according to the invention.

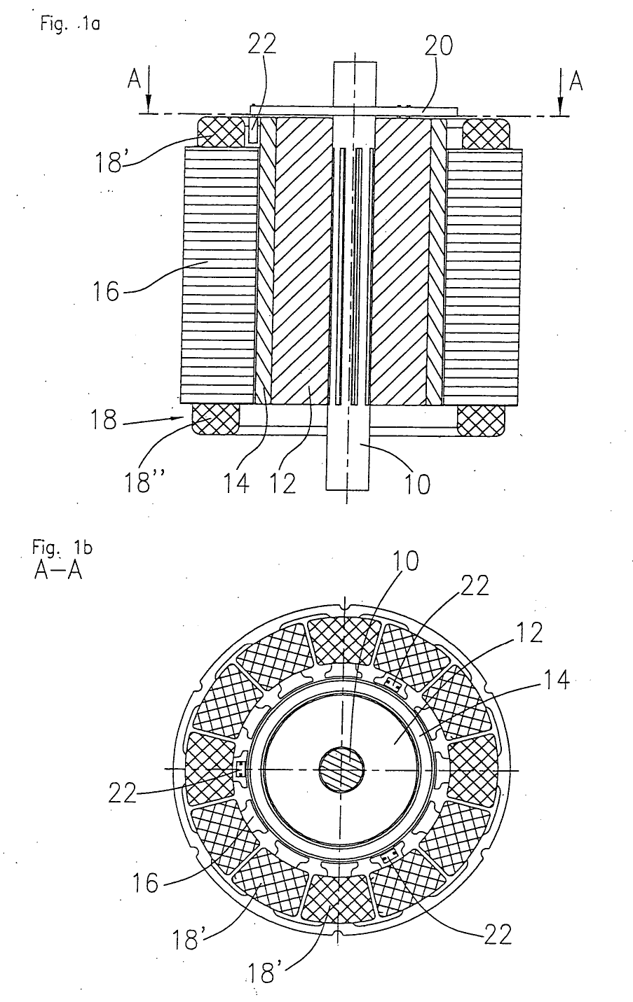

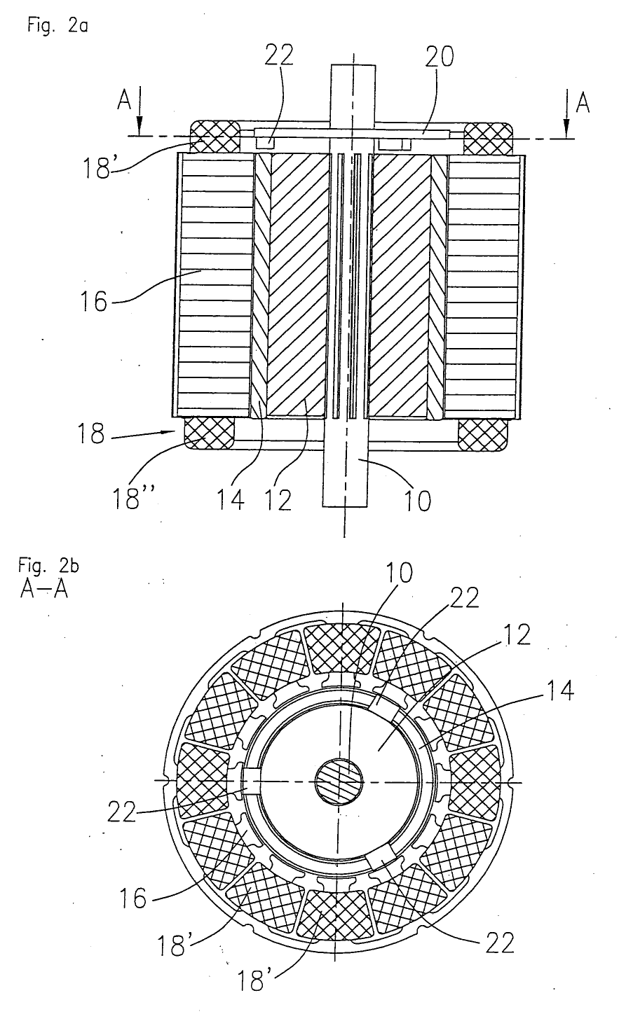

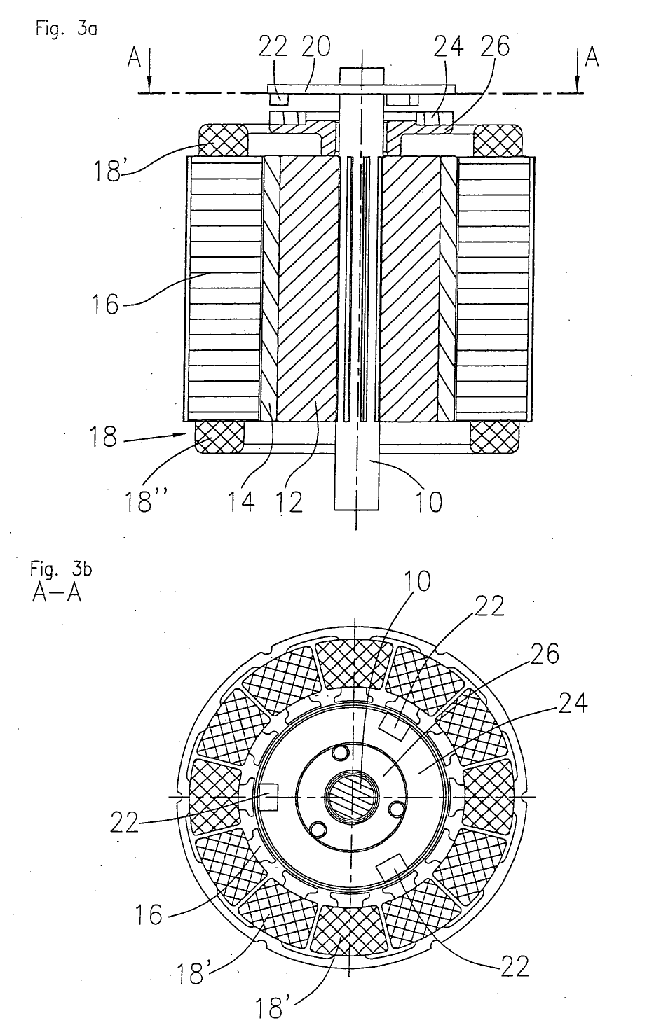

### DETAILED DESCRIPTION OF A PREFERRED EMBODIMENT

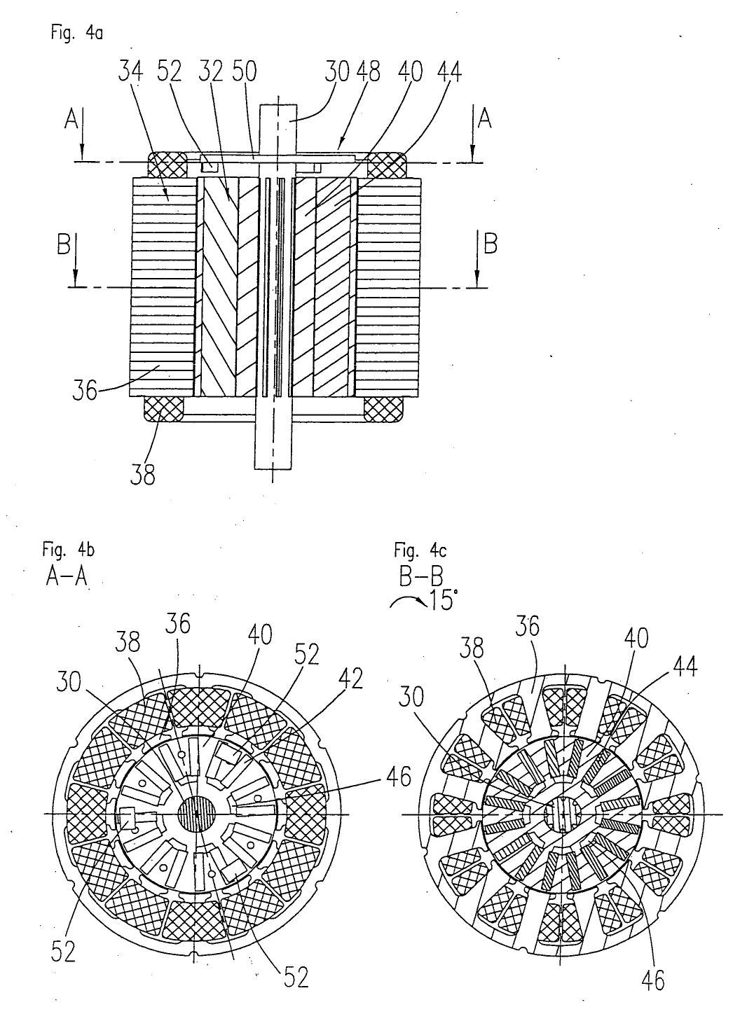

As shown in FIGS. 4a to 4c, the electric motor according to the invention, which is preferably designed as a brushless DC motor, comprises a shaft 30 that carries a rotor arrangement 32. The rotor arrangement 32 is coaxially inserted into a stator arrangement which is basically constructed in the same way as in the prior art. That means that the stator arrangement comprises a stator body 36 and windings 38. The stator body 36 can be built up of a stack of stamped laminations that forms a stator back yoke ring having stator poles that carry windings 38, as can best be seen from FIG. 4c. The rotor arrangement 32 comprises a rotor body 40 that has spoke-like recesses 42 into which the permanent magnets are inserted. In the preferred embodiment, the recesses 42 to receive the permanent magnets are bridged in pairs by a cutout 46. This cutout 46 is used to suppress radial stray flux in the interior of the rotor arrangement 32 towards the shaft 30.

As is apparent when FIGS. 4a and 4b are viewed together, the recesses 42 extend in an axial direction over the entire length of the rotor body 40 and are open at its end face, so that at the end faces of the rotor, the permanent magnets 44 emit a relatively large lateral stray field.

A sensor arrangement 48 is positioned at one end face of the rotor arrangement 32, the sensor arrangement 48 being seated substantially within the winding head of the winding 38. The sensor arrangement 48 comprises a circuit board 50 and magnetic sensors 52 that are mounted on the circuit board. The circuit board 50 is connected to the stator or to a flange. The flange preferably carries bearings to support the shaft. The magnetic sensors 52 are preferably Hall elements, although other magnetic sensors such as GMR sensors and MR sensors could be used. Depending on the distance to the embedded permanent magnets 44, the magnetic sensors can either be disposed vertically or horizontally in order to measure a tangential or an axial component of the axial stray field of the permanent magnets 44. A vertical arrangement of the magnetic sensors 52 means that the direction of measurement of the sensors is parallel to the end face of the rotor and a horizontal arrangement designates a perpendicular alignment of the magnetic sensors to the end face.

Three magnetic sensors are preferably used which are offset in phase at 120°. A method of adjusting the sensor arrangement 48 to determine the rotational position of the rotor and a possible means of measuring and evaluating the signals of the magnetic sensors 52 is described in German Patent DE 102 53 388 by the same applicant.

The invention has the advantage that the signal distances of the magnetic sensors 52 are identical to the magnetic pole length of the permanent magnets 44 of the rotor so that the signal necessary for motor commutation can be directly derived from the magnetic sensors 52. Since the axial stray field of the rotor having embedded permanent magnets 44 is relatively high in the embodiment according to the invention, a comparably large spacing between the magnetic sensors 52 and the end face of the rotor arrangement 32 of up to 1 mm can be provided. The distance tolerances can also be correspondingly high. This means that the rotational position sensors can be manufactured at low-cost.

In a preferred embodiment of the invention, the preferably analogue output signals of the magnetic sensors 52 are measured and compared to the signals of a precise reference sensor in order to subsequently generate and store correction values. The position values determined by means of the magnetic sensors 52 can be corrected using these correction values and can be passed on via an electronic interface, such as a bus system, to a superordinate motor regulator or controller for further processing. This means that the output signal of the magnetic sensors 52 may not only be used to generate signals for motor commutation but going beyond this also to determine the position, rotational direction and rotational speed of the electric motor. In this regard, reference is made to the above-mentioned patent by the same applicant.

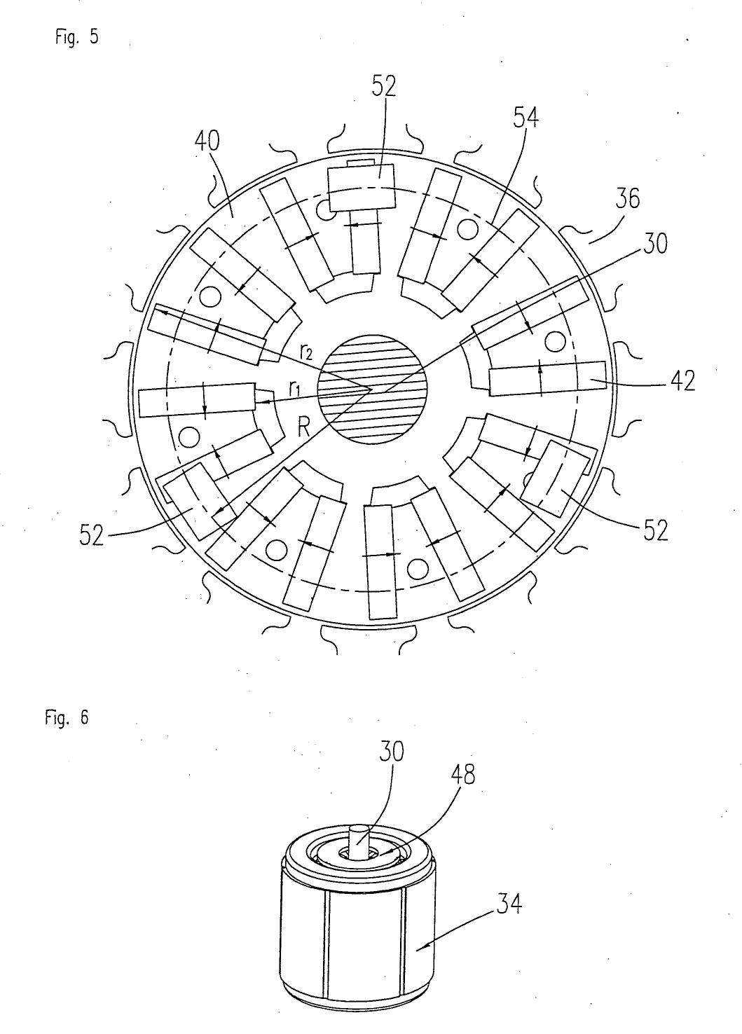

FIG. 5 shows a detail of FIG. 4b in a different view, the stator arrangement being mostly left out. The direction of magnetization of the permanent magnets 44 is indicated by arrows (N→S). In FIG. 5, a circle 54 having a radius R is indicated by a broken line, the magnetic sensors 52 being preferably disposed on this circle. This circle lies within an (imaginary) circular disk that is defined by the minimum radius (r1) and the maximum radius (r2) of the permanent magnets 44. In other words, the magnetic sensors 52 are arranged at the end face of the rotor arrangement 32 in such a way that they lie opposite the corresponding end faces of the permanent magnets 44 in order to measure as great a portion of the axial stray field as possible. The magnetic sensors 52 are preferably offset in phase with respect to each other by 120°. This arrangement ensures comparably greater tolerance vis-a-vis faulty positioning of the sensors.

In conjunction with FIG. 4a, FIG. 6 makes it clear that the electric motor having the sensor arrangement 48 according to the invention can be manufactured with only slight additional work and expense compared to an electric motor that does not have a sensor arrangement, the overall height of the motor not increasing as a whole.

The features revealed in the above description, the claims and the figures can be important for the realization of the invention in its various embodiments both individually and in any combination whatsoever. For example, it is possible to use the invention in conjunction with a rotor arrangement in which the permanent magnets are not embedded spoke-like in the rotor body, but in some other way. The permanent magnets could be arranged, for example, in lines that largely correspond to Halbach magnetization as described, for example, in German Patent Applications DE 10 2004 017 507 and DE 10 2004 017 157. Moving the magnetic sensors further in the direction of the inner circle, i.e. in FIG. 5, for example, in the direction of radius r1, goes to ensure that the measured axial stray fields are largely independent of the stator field. As described in the introduction, it is also possible to separate the stator and rotor by a ferromagnetic sleeve as is known from DE 10 2004 056 303.

### IDENTIFICATION REFERENCE LIST

10 Shaft
12 Rotor body
14 Permanent magnets
16 Stator body
18 Windings
18′,18″ Winding heads
20 Circuit board
22 Hall elements
24 Sensor magnets
26 Carrier
30 Shaft
32 Rotor arrangement
34 Stator arrangement
36 Stator body
38 Windings
40 Rotor body
42 Recesses
44 Permanent magnets
46 Cutout
48 Sensor arrangement
50 Circuit board
52 Magnetic sensors
54 Circle

1. An electric machine, in particular a brushless DC motor, having a stator arrangement (34) and a rotor arrangement (32) that are arranged coaxially with respect to one another, the rotor arrangement having a rotor body (40) and permanent magnets (44) embedded in the rotor body, wherein at least one magnetic sensor (52) for the purpose of measuring the rotational position of the rotor body (40) is disposed at an end face of the rotor body and is located directly opposite this end face.

2. A machine according to claim 1, wherein the permanent magnets (44) are arranged spoke-like in the rotor body (40).

3. A machine according to claim 1, wherein recesses (42) are formed in the rotor body (40) to receive the permanent magnets (44), the recesses being open on at least one end face.

4. A machine according to claim 3, wherein the end face of the rotor body (40) is sealed by a magnetic or non-magnetic material after the magnets are mounted.

5. A machine according to claim 2, wherein the magnetic sensor (52) is disposed on an annulus whose radius R lies between the inner radius (r1) and the outer radius (r2) of the embedded permanent magnets (44).

6. A machine according to claim 1, wherein the magnetic sensor (52) comprises Hall sensors, MR or GMR sensors.

7. A machine according to claim 5, wherein two, three, or four magnetic sensors (52) are disposed at the end face of the rotor body (40), offset in phase at 180°, 120° or 90°.

8. A machine according to claim 1, wherein the magnetic sensor (52) is disposed on a circuit board (50).

9. A machine according to claim 1, wherein a sleeve is inserted between the rotor arrangement (32) and the stator arrangement (34).

10. A machine according to claim 9, wherein the sleeve comprises a ferromagnetic material.

11. A machine according to claim 9, wherein the sleeve protrudes in an axial direction beyond at least the one end face of the rotor arrangement (32) at which the magnetic sensor arrangement (48) is positioned.
